(19) United States
(12) Patent Application Publication
(10) Pub. No.: US 2020/0243851 A1
(43) Pub. Date: Jul. 30, 2020

(54) ELECTRODE, ELECTRODE ELEMENT, NON-AQUEOUS ELECTROLYTE POWER STORAGE ELEMENT, AND METHOD FOR MANUFACTURING ELECTRODE

(71) Applicants: Keigo Takauji, Kanagawa (JP); Miku Ohkimoto, Kanagawa (JP); Toru Ushirogochi, Kanagawa (JP); Hideo Yanagita, Tokyo (JP)

(72) Inventors: Keigo Takauji, Kanagawa (JP); Miku Ohkimoto, Kanagawa (JP); Toru Ushirogochi, Kanagawa (JP); Hideo Yanagita, Tokyo (JP)

(21) Appl. No.: 16/774,095

(22) Filed: Jan. 28, 2020

(30) Foreign Application Priority Data
Jan. 28, 2019 (JP) 2019-012591

(51) Int. Cl. H01M 4/36; H01M 4/04; H01M 2/16; H01M 4/62; H01M 4/02

(52) U.S. Cl. CPC H01M 4/366; H01M 4/0402; H01M 2004/021; H01M 4/0471; H01M 4/628; H01M 2/1673

(57) ABSTRACT

An electrode is provided. The electrode includes an electrode substrate, an electrode composite layer on the electrode substrate, and a porous insulating layer on the electrode composite layer. The electrode composite layer contains an active material. The porous insulating layer contains a resin as a main component. At least a part of the porous insulating layer is present inside the electrode composite layer and integrated with a surface of the active material. The porous insulating layer has a direct current resistance value of 40 MΩ or more either before or after a bending test in which the electrode is bent 20 times by a cylindrical mandrel bending tester equipped with a cylindrical mandrel having a diameter of 4 mm.

### CROSS-REFERENCE TO RELATED APPLICATIONS

This patent application is based on and claims priority pursuant to 35 U.S.C. § 119(a) to Japanese Patent Application No. 2019-012591, filed on Jan. 28, 2019, in the Japan Patent Office, the entire disclosure of which is hereby incorporated by reference herein.

### BACKGROUND

### Technical Field

The present disclosure relates to an electrode, an electrode element, a non-aqueous electrolyte power storage element, and a method for manufacturing an electrode.

### Description of the Related Art

Demands for higher output, higher capacity, and longer life of power storage elements (e.g., batteries) and power generation elements (e.g., fuel cells) are rapidly increasing. However, there still exist various problems related to the safety of the elements. One of the important issues is to prevent a thermal runaway reaction caused by a short circuit between electrodes.

The thermal runaway reaction occurs when an abnormally large current flows due to a short circuit between the electrodes and the element thereby generates heat to cause a decomposition reaction, etc. of the electrolyte and a further rise in the temperature so that a flammable gas is generated in the element.

Therefore, to prevent a thermal runaway reaction, the electrodes should be reliably insulated in all situations. In conventional technologies, the electrodes are insulated by a separator containing polyethylene or polypropylene as a main component, but the separator is not tightly adhered to the electrodes. Therefore, when such a power storage element is deformed by an external impact or when a conductive foreign substance such as a nail penetrates the element, it is likely that a gap is generated between the separator and the electrode to cause a short circuit.

Various attempts have been made to solve this problem. For example, a separator having a shutdown function for preventing a thermal runaway reaction has been proposed that melts upon heat generation by a power storage element to clog openings.

The shutdown function is activated when the temperature reaches a specific temperature or higher, so that no discharge occurs between the positive electrode and the negative electrode and a thermal runaway reaction is thus prevented. As another example, a separator having a multi-stage shutdown function has also been proposed. As another example, a separator having been enhanced in shutdown function by addition of an auxiliary agent has also been proposed.

### SUMMARY

In accordance with some embodiments of the present invention, an electrode is provided. The electrode includes an electrode substrate, an electrode composite layer on the electrode substrate, and a porous insulating layer on the electrode composite layer. The electrode composite layer contains an active material. The porous insulating layer contains a resin as a main component. At least a part of the porous insulating layer is present inside the electrode composite layer and integrated with a surface of the active material. The porous insulating layer has a direct current resistance value of 40 MΩ or more either before or after a bending test in which the electrode is bent 20 times by a cylindrical mandrel bending tester equipped with a cylindrical mandrel having a diameter of 4 mm.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a cross-sectional view of a negative electrode for use in a non-aqueous electrolyte power storage element according to the first embodiment;

FIG. 2 is a cross-sectional view of a positive electrode for use in a non-aqueous electrolyte power storage element according to the first embodiment;

FIG. 3 is a cross-sectional view of an electrode element for use in a non-aqueous electrolyte power storage element according to the first embodiment;

FIG. 4 is a cross-sectional view of a non-aqueous electrolyte power storage element according to the first embodiment;

FIGS. 5A and 5B are schematic views illustrating a porous insulating layer;

FIGS. 6A to 6C are diagrams for explaining a process (No. 1) for manufacturing a non-aqueous electrolyte power storage element according to the first embodiment;

FIGS. 7A to 7C are diagrams for explaining a process (No. 2) for manufacturing a non-aqueous electrolyte power storage element according to the first embodiment;

FIG. 8 is a diagram for explaining a process (No. 3) for manufacturing a non-aqueous electrolyte power storage element according to the first embodiment;

FIG. 9 is a cross-sectional view of an electrode element for use in a non-aqueous electrolyte power storage element according to Modification 1 of the first embodiment;

FIGS. 10A and 10B are diagrams for explaining a method for evaluating insulation property; and

FIG. 11 is a table for explaining Examples and Comparative Example.

The accompanying drawings are intended to depict example embodiments of the present invention and should not be interpreted to limit the scope thereof The accompanying drawings are not to be considered as drawn to scale unless explicitly noted.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Embodiments of the present invention are described in detail below with reference to accompanying drawings. In describing embodiments illustrated in the drawings, specific terminology is employed for the sake of clarity. However, the disclosure of this patent specification is not intended to be limited to the specific terminology so selected, and it is to be understood that each specific element includes all technical equivalents that have a similar function, operate in a similar manner, and achieve a similar result.

For the sake of simplicity, the same reference number will be given to identical constituent elements such as parts and materials having the same functions and redundant descriptions thereof omitted unless otherwise stated.

Within the context of the present disclosure, if a first layer is stated to be “overlaid” on, or “overlying” a second layer, the first layer may be in direct contact with a portion or all of the second layer, or there may be one or more intervening layers between the first and second layer, with the second layer being closer to the substrate than the first layer.

The shutdown function in conventional technologies is insufficient for preventing a thermal runaway, because the positive electrode and the negative electrode are kept in contact with the electrolyte at high temperatures and there still exists a possibility that a decomposition reaction, etc. of the electrolyte occurs. The safety of such power storage elements cannot be said to be sufficient, and there is room for improvement in long-term reliability.

In accordance with some embodiments of the present invention, an electrode is provided that provides excellent safety and long-term reliability when mounted on a power storage element.

Embodiments of the present invention are described in detail below with reference to the drawings. In each drawing, the same reference numerals are given to the same components, and redundant explanation may be omitted.

### First Embodiment

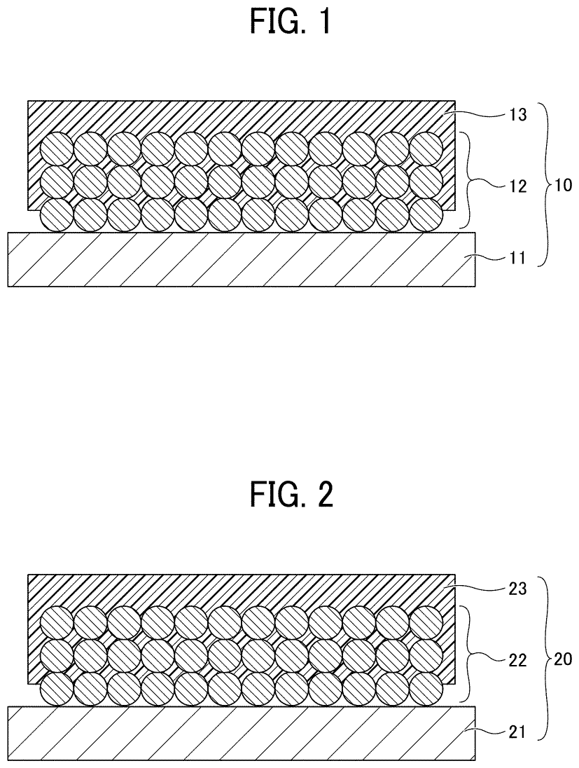

FIG. 1 is a cross-sectional view of a negative electrode for use in a non-aqueous electrolyte power storage element according to the first embodiment. Referring to FIG. 1, a negative electrode 10 includes a negative electrode substrate 11, a negative electrode composite layer 12 formed on the negative electrode substrate 11, and a porous insulating layer 13 formed on the negative electrode composite layer 12. The shape of the negative electrode 10 is not particularly limited and can be suitably selected to suit to a particular application. For example, the negative electrode 10 may be in a flat-plate form.

In the negative electrode 10, at least a part of the porous insulating layer 13 is present inside the negative electrode composite layer 12 and integrated with a surface of an active material constituting the negative electrode composite layer 12. Here, the term “integration” does not refer to a state in which a member such as a film is simply laminated as an upper layer on a lower layer, but refers to a state in which a part of the upper layer enters the lower layer and the surface of the material constituting the upper layer is bonded with the surface of the material constituting the lower with the interface therebetween being unclear.

Although the negative electrode composite layer 12 is schematically illustrated as having a structure in which spherical particles are stacked, the particles constituting the negative electrode composite layer 12 are either spherical or non-spherical, and particles of various shapes and various sizes are mixed in the layer.

FIG. 2 is a cross-sectional view of a positive electrode for use in a non-aqueous electrolyte power storage element according to the first embodiment. Referring to FIG. 2, a positive electrode 20 includes a positive electrode substrate 21, a positive electrode composite layer 22 formed on the positive electrode substrate 21, and a porous insulating layer 23 formed on the positive electrode composite layer 22. The shape of the positive electrode 20 is not particularly limited and can be suitably selected to suit to a particular application. For example, the positive electrode 20 may be in a flat-plate form.

In the positive electrode 20, at least a part of the porous insulating layer 23 is present inside the positive electrode composite layer 22 and integrated with a surface of an active material constituting the positive electrode composite layer 22.

Although the positive electrode composite layer 22 is schematically illustrated as having a structure in which spherical particles are stacked, the particles constituting the positive electrode composite layer 22 are either spherical or non-spherical, and particles of various shapes and various sizes are mixed in the layer.

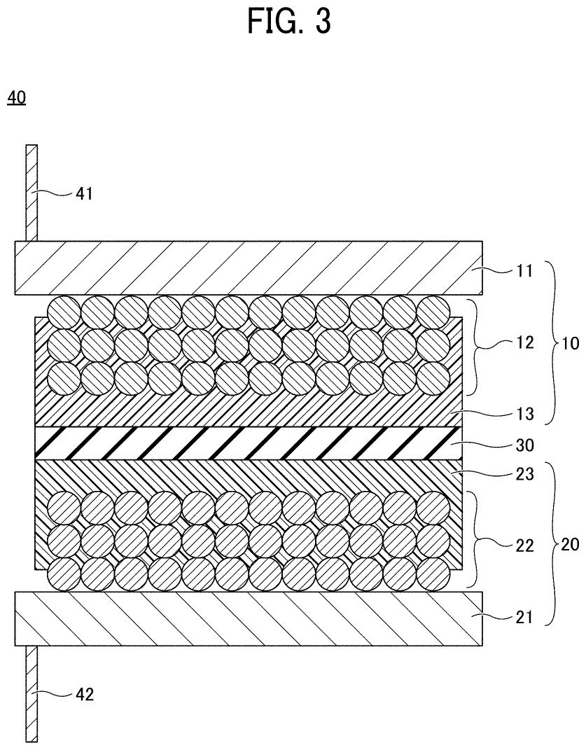

FIG. 3 is a cross-sectional view of an electrode element for use in a non-aqueous electrolyte power storage element according to the first embodiment. Referring to FIG. 3, an electrode element 40 has a structure in which the negative electrode 10 and the positive electrode 20 are stacked via a separator 30 with being insulated from each other. More specifically, the electrode element 40 has a structure in which the negative electrode 10 and the positive electrode 20 are stacked via the separator 30 with the negative electrode substrate 11 and the positive electrode substrate 21 facing outward. A negative electrode lead wire 41 is connected to the negative electrode substrate 11. A positive electrode lead wire 42 is connected to the positive electrode substrate 21.

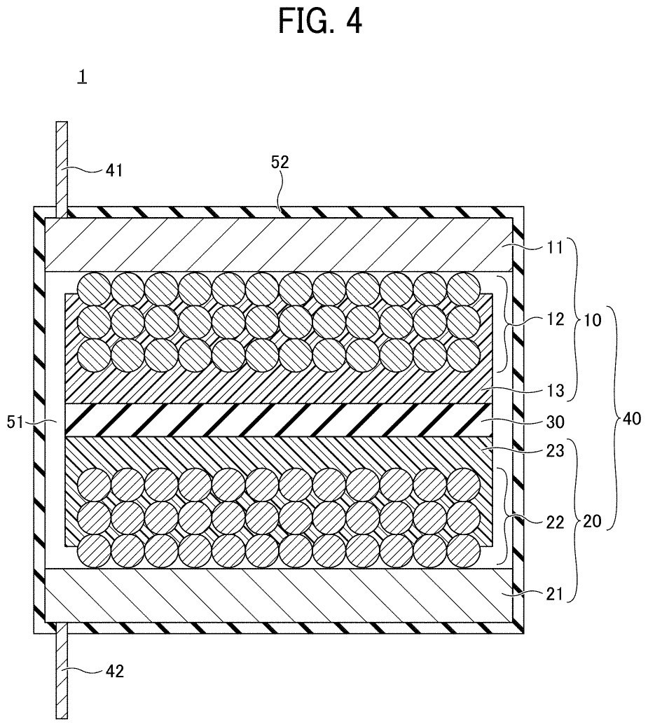

FIG. 4 is a cross-sectional view of a non-aqueous electrolyte power storage element according to the first embodiment. Referring to FIG. 4, a non-aqueous electrolyte power storage element 1 has a structure in which an electrolyte layer 51 is formed by injecting a non-aqueous electrolyte into the electrode element 40 and sealed with an exterior 52. In the non-aqueous electrolyte power storage element 1, the negative electrode lead wire 41 and the positive electrode lead wire 42 are drawn out of the exterior 52. The non-aqueous electrolyte power storage element 1 may further include other members, as necessary. The non-aqueous electrolyte power storage element 1 is not particularly limited and can be suitably selected to suit to a particular application. Examples thereof include, but are not limited to, a non-aqueous electrolyte secondary battery and a non-aqueous electrolyte capacitor.

The shape of the non-aqueous electrolyte power storage element 1 is not particularly limited and can be suitably selected from various generally-employed shapes to suit to a particular application. For example, the shape may be of a laminate type, a cylinder type in which a sheet electrode and a separator are assembled in a spiral manner, another cylinder type in which a pellet electrode and a separator are combined into an inside-out structure, or a coin type in which a pellet electrode and a separator are laminated.

The non-aqueous electrolyte power storage element 1 is described in detail below. In the following descriptions, the negative electrode and the positive electrode may be collectively referred to as “electrode”, the negative electrode substrate and the positive electrode substrate may be collectively referred to as “electrode substrate”, and the negative electrode composite layer and the positive electrode composite layer may be collectively referred to as “electrode composite layer”.

### Electrode

### Electrode Substrate

Each of the negative electrode substrate 11 and positive electrode substrate 21 is not particularly limited as long as it is a substrate having planarity and conductivity and may be any of an aluminum foil, a copper foil, a stainless steel foil, and a titanium foil, each of which is generally used for secondary batteries and capacitors serving as power storage elements, particularly suitable for lithium ion secondary batteries, an etched foil with fine holes formed by etching the above foil, and a perforated electrode substrate used for lithium ion capacitors.

Further, carbon paper or a fibrous electrode used in power generation elements such as fuel cells that is put into a non-woven or woven planar form, and the above-described perforated electrode substrate having fine holes may also be used. Moreover, for solar elements, a flat substrate made of glass or plastic on which a transparent semiconductor film of indium-titanium oxide or zinc oxide is formed or a thin conductive electrode film is deposited may also be used in addition to the above-described materials.

### Electrode Composite Layer

The negative electrode composite layer 12 and the positive electrode composite layer 22 are not particularly limited and can be suitably selected to suit to a particular application. For example, the negative electrode composite layer 12 and the positive electrode composite layer 22 may contain at least an active material (a negative electrode active material or a positive electrode active material) and optionally a binder, a thickener, a conducting agent, or the like.

The negative electrode composite layer 12 and the positive electrode composite layer 22 are each formed by dispersing a powdery active material and a catalyst composition in a liquid and applying the liquid onto an electrode substrate, generally by means of printing using a spray, a dispenser, or a die coater or pull-up coating, followed by drying, to be fixed on the electrode substrate.

The negative electrode active material is not particularly limited as long as it is a material capable of reversibly occluding and releasing alkali metal ions. Typically, carbon materials including graphite having a graphite-type crystal structure may be used as the negative electrode active material. Examples of such carbon materials include, but are not limited to, natural graphite, spherical or fibrous synthetic graphite, poorly-graphitizable carbon (hard carbon), and easily-graphitizable carbon (soft carbon). Other than the carbon materials, lithium titanate may also be used. For improving energy density of lithium ion batteries, high capacity materials such as silicon, tin, silicon alloy, tin alloy, silicon oxide, silicon nitride, and tin oxide can also be used as the negative electrode active material.

Examples of the active material for nickel hydrogen batteries include, but are not limited to, hydrogen storage alloys, specifically AB₂-type or A₂B-type hydrogen storage alloys such as a Zr—Ti—Mn—Fe—Ag—V—Al—W alloy and a Ti₁₅Zr₂₁V₁₅Ni₂₉Cr₅Co₅Fe₁Mn₈ alloy.

The positive electrode active material is not particularly limited as long as it is a material capable of reversibly occluding and releasing alkali metal ions. Typically, alkali-metal-containing transition metal compounds may be used as the positive electrode active material. Examples of the lithium-containing transition metal compounds include, but are not limited to, a composite oxide comprising lithium and at least one element selected from the group consisting of cobalt, manganese, nickel, chromium, iron, and vanadium.

Specific examples of the composite oxide include, but are not limited to, lithium-containing transition metal oxides such as lithium cobalt oxide, lithium nickel oxide, and lithium manganese oxide; olivine-type lithium salts such as LiFePO₄; chalcogen compounds such as titanium disulfide and molybdenum disulfide; and manganese dioxide.

The lithium-containing transition metal oxide refers to a metal oxide containing lithium and a transition metal, or that in which a part of the transition metal therein is substituted with a different element. Examples of the different element include, but are not limited to, Na, Mg, Sc, Y, Mn, Fe, Co, Ni, Cu, Zn, Al, Cr, Pb, Sb, and B. Among these, Mn, Al, Co, Ni, and Mg are preferred. One type or two or more types of different elements may be contained in the compound. Each of the above-described positive electrode active materials can be used alone or in combination with others. Examples of the active material for nickel hydrogen batteries include, but are not limited to, nickel hydroxide.

Examples of the binder of the negative electrode or positive electrode include, but are not limited to, polyvinylidene fluoride (PVDF), polytetrafluoroethylene (PTFE), polyethylene, polypropylene, aramid resin, polyamide, polyimide, polyamideimide, polyacrylonitrile, polyacrylic acid, polyacrylic acid methyl ester, polyacrylic acid ethyl ester, polyacrylic acid hexyl ester, polymethacrylic acid, polymethacrylic acid methyl ester, polymethacrylic acid ethyl ester, polymethacrylic acid hexyl ester, polyvinyl acetate, polyvinyl pyrrolidone, polyether, polyether sulfone, hexafluoropolypropylene, styrene butadiene rubber, and carboxymethyl cellulose.

Examples of the binder further include copolymers of two or more materials selected from tetrafluoroethylene, hexafluoroethylene, hexafluoropropylene, perfluoroalkyl vinyl ether, vinylidene fluoride, chlorotrifluoroethylene, ethylene, propylene, pentafluoropropylene, fluoromethyl vinyl ether, acrylic acid, and hexadiene. In addition, mixtures of two or more materials selected from these materials may also be used.

Examples of the conducting agent contained in the electrode composite layer include, but are not limited to, graphites such as natural graphite and synthetic graphite; carbon blacks such as acetylene black, Ketjen black, channel black, furnace black, lamp black, and thermal black; conductive fibers such as carbon fibers and metal fibers; carbon fluoride; powders of metals such as aluminum; conductive whiskers such as zinc oxide and potassium titanate; conductive metal oxides such as titanium oxide; and organic conductive materials such as phenylene derivatives and graphene derivatives.

Generally, in fuel cells, the active material serves as a catalyst for the positive electrode or the negative electrode. The catalyst comprises catalyst particles (e.g., fine particles of a metal such as platinum, ruthenium, and platinum alloy) supported on a catalyst carrier (e.g., carbon). The catalyst particles can be made supported on the surface of the catalyst carrier by suspending the catalyst carrier in water, then adding precursors of the catalyst particles thereto to make them dissolved in the suspension, and further adding an alkali to produce a hydroxide of the metal. Here, specific examples of the precursors of the catalyst particles include, but are not limited to, chloroplatinic acid, dinitrodiamino platinum, platinum(IV) chloride, platinum(II) chloride, bisacetylacetonatoplatinum, dichlorodiammine platinum, dichlorotetramine platinum, platinum sulfate chlororuthenate, hexachloroiridate, hexachlororhodate, ferric chloride, cobalt chloride, chromium chloride, gold chloride, silver nitrate, rhodium nitrate, palladium chloride, nickel nitrate, iron sulfate, and copper chloride. The catalyst carrier is then applied onto the electrode substrate and reduced under a hydrogen atmosphere or the like, thus preparing an electrode composite layer having a surface coated with the catalyst particles (active material).

In solar cells, the active material may be tungsten oxide powder, titanium oxide powder, or a semiconductor layer of an oxide (e.g., SnO₂, ZnO, ZrO₂, Nb₂O₅, CeO₂, SiO₂, and Al₂O₃) carrying a dye (e.g., ruthenium-tris transition metal complex, ruthenium-bis transition metal complex, osmium-tris transition metal complex, osmium-bis transition metal complex, ruthenium-cis-diaqua-bipyridyl complex, phthalocyanine and porphyrin, and organic-inorganic perovskite crystal).

### Porous Insulating Layer

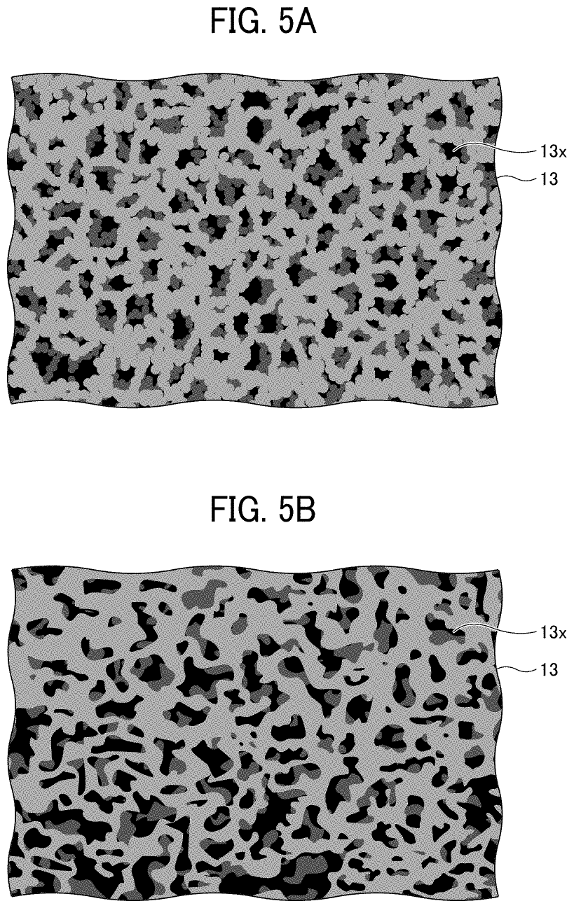

FIGS. 5A and 5B are schematic planar and cross-sectional views, respectively, of the porous insulating layer. FIGS. 5A and 5B schematically illustrates the porous insulating layer 13, and the porous insulating layer 23 has the same structure.

The porous insulating layers 13 and 23 each contain a resin as a main component. Here, containing a resin as a main component refers to a state in which the resin occupies 50% by mass or more of all the materials constituting the porous insulating layer.

Preferably, the resin forming the porous insulating layers 13 and 23 is a polymer of a curable resin composition containing a curable resin having an elongation of 15% or more at break. In addition, it is preferable that the curable resin accounts for 30% by weight or more of the resin forming the porous insulating layers 13 and 23. When these requirements are satisfied, the porous insulating layers 13 and 23 exhibit sufficient flexibility and cycle characteristics.

The structures of the porous insulating layers 13 and 23 are not particularly limited. However, for secondary batteries only, the porous insulating layer preferably has a bicontinuous structure having a three-dimensional branched network structure of a cured resin as the backbone, for ensuring electrolyte permeability and good ionic conductivity.

The porous insulating layer 13 has a plurality of voids 13x. Preferably, the voids 13x are three-dimensionally spread with one void 13x communicated with other voids 13x around. Similarly, the porous insulating layer 23 has a plurality of voids. Preferably, the voids are three-dimensionally spread with one void communicated with other voids around. As the voids are communicated, the electrolyte can sufficiently penetrate the layer and ion movement is not inhibited.

The cross-sectional shape of the voids of the porous insulating layers 13 and 23 may be in various shapes, such as a substantially circular shape, a substantially elliptical shape, or a substantially polygonal shape, and in various sizes. Here, the size of the void refers to the length of the longest portion in the cross-sectional shape. The size of the void can be determined from a cross-sectional photograph taken with a scanning electron microscope (SEM).

The size of the void of the porous insulating layers 13 and 23 is not particularly limited. For secondary batteries only, the size of the void is preferably about 0.1 to 10 μm for electrolyte permeability.

A polymerizable compound is a precursor of a resin forming the porous structure and may be any resin capable of forming a cross-linked structure by irradiation with light or heat. Examples thereof include, but are not limited to, acrylate resins, methacrylate resins, urethane acrylate resins, vinyl ester resins, unsaturated polyesters, epoxy resins, oxetane resins, vinyl ethers, and resins utilizing an ene-thiol reaction. Among these, acrylate resins, methacrylate resins, urethane acrylate resins, and vinyl ester resins, which are able to easily form the structure by radical polymerization due to their high reactivity, are preferred in terms of productivity. These resins can be appropriately selected depending on physical properties required for the porous insulating layer, but urethane acrylate resins are preferred for imparting flexibility.

Further, a resin material having a curable group equivalent of 300 g/eq or more is preferable included. This makes it possible to reduce shrinkage and strain generated at curing to produce a porous insulating layer and an electrode tightly adhered to each other.

The resin (i.e., polymer of the curable resin) preferably has a glass transition temperature (Tg) of 100 degrees C. or higher, more preferably 120 degrees C. or higher, for heat resistance. In this case, the resulting porous insulating layer maintains the insulating function without causing a shape change even at a high temperature, so that further improvement in safety can be expected.

The resin may be obtained by preparing a mixture of a polymerizable compound that is curable by light or heat and a compound that generates a radical or an acid by light or heat. To form the porous insulating layers 13 and 23 by polymerization-induced phase separation, an ink in which the above-prepared mixture is mixed with a porogen in advance is to be prepared.

The polymerizable compound has at least one radical-polymerizable functional group. Examples thereof include, but are not limited to, monofunctional, difunctional, and trifunctional or higher radical-polymerizable compounds, functional monomers, and radical-polymerizable oligomers. Among these compounds, difunctional or higher radical-polymerizable compounds are preferred.

Specific examples of the monofunctional radical-polymerizable compounds include, but are not limited to, 2-(2-ethoxyethoxy)ethyl acrylate, methoxypolyethylene glycol monoacrylate, methoxypolyethylene glycol monomethacrylate, phenoxypolyethylene glycol acrylate, 2-acryloyloxyethyl succinate, 2-ethylhexyl acrylate, 2-hydroxyethyl acrylate, 2-hydroxypropyl acrylate, tetrahydrofurfuryl acrylate, 2-ethylhexylcarbitol acrylate, 3-methoxybutyl acrylate, benzyl acrylate, cyclohexyl acrylate, isoamyl acrylate, isobutyl acrylate, methoxytriethylene glycol acrylate, phenoxytetraethylene glycol acrylate, cetyl acrylate, isostearyl acrylate, stearyl acrylate, and styrene monomer. Each of these compounds can be used alone or in combination with others.

Specific examples of the difunctional radical-polymerizable compounds include, but are not limited to, 1,3-butanediol diacrylate, 1,4-butanediol diacrylate, 1,4-butanediol dimethacrylate, 1,6-hexanediol diacrylate, 1,6-hexanediol dimethacrylate, diethylene glycol diacrylate, polyethylene glycol diacrylate, neopentyl glycol diacrylate, EO-modified bisphenol A diacrylate, EO-modified bisphenol F diacrylate, neopentyl glycol diacrylate, and tricyclodecane dimethanol diacrylate. Each of these compounds can be used alone or in combination with others.

Specific examples of the trifunctional or higher radical-polymerizable compounds include, but are not limited to, trimethylolpropane triacrylate (TMPTA), trimethylolpropane trimethacrylate, EO-modified trimethylolpropane triacrylate, PO-modified trimethylolpropane triacrylate, caprolactone-modified trimethylolpropane triacrylate, HPA-modified trimethylolpropane trimethacrylate, pentaerythritol triacrylate, pentaerythritol tetraacrylate (PETTA), glycerol triacrylate, ECH-modified glycerol triacrylate, EO-modified glycerol triacrylate, PO-modified glycerol triacrylate, tris(acryloxyethyl)isocyanurate, dipentaerythritol hexaacrylate (DPHA), caprolactone-modified dipentaerythritol hexaacrylate, dipentaerythritol hydroxypentaacrylate, alkyl-modified dipentaerythritol pentaacrylate, alkyl-modified dipentaerythritol tetraacrylate, alkyl-modified dipentaerythritol triacrylate, dimethylolpropane tetraacrylate (DTMPTA), pentaerythritol ethoxytetraacrylate, EO-modified phosphoric triacrylate, and 2,2,5,5-tetrahydroxymethylcyclopentanone tetraacrylate. Each of these compounds can be used alone or in combination with others.

Examples of photopolymerization initiators include photoradical generators. Examples thereof include photoradical polymerization initiators such as Michler's ketone and benzophenone known under the trade names IRGACURE and DAROCUR. Specific preferred examples thereof include, but are not limited to, benzophenone, acetophenone derivatives (e.g., α-hydroxy- or α-amino-acetophenone), 4-aroyl-1,3-dioxolane, benzyl ketal, 2,2-diethoxyacetophenone, p-dimethylaminoacetophene, p-dimethylaminopropiophenone, benzophenone, 2-chlorobenzophenone, pp′-dichlorobenzophene, pp′-bisdiethylaminobenzophenone, Michler's ketone, benzyl, benzoin, benzyl dimethyl ketal, tetramethylthiuram monosulfide, thioxanthone, 2-chlorothioxanthone, 2-methylthioxanthone, azobisisobutyronitrile, benzoin peroxide, di-tert-butyl peroxide, 1-hydroxycyclohexyl phenyl ketone, 2-hydroxy-2-methyl-1-phenyl-1-one, 1-(4-isopropylphenyl)-2-hydroxy-2-methylpropan-1-one, methyl benzoylformate, benzoin alkyl ethers and esters such as benzoin isopropyl ether, benzoin methyl ether, benzoin ethyl ether, benzoin ether, benzoin isobutyl ether, benzoin n-butyl ether, and benzoin n-propyl ether, 1-hydroxy-cyclohexyl-phenyl-ketone, 2-benzyl-2-dimethylamino-1-(4-morpholinophenyl)-butanone-1, 1-hydroxy-cyclohexyl-phenyl-ketone, 2,2-dimethoxy-1,2-diphenylethan-1-one, bis(η5-2,4-cyclopentadien-1-yl)-bis(2,6-difluoro-3-(1H-pyrrol-1-yl)-phenyl)titanium, bis(2,4,6-trimethylbenzoyl)-phenylphosphine oxide, 2-methyl-1-[4-(methylthio)phenyl]-2-morpholinopropan-1-one, 2-hydroxy-2-methyl-1-phenyl-propan-1-one (DAROCUR 1173), bis(2,6-dimethoxybenzoyl)-2,4,4-trimethyl-pentylphosphine oxide, 1-[4-(2-hydroxyethoxy)-phenyl]-2-hydroxy-2-methyl-1-propan-1-one monoacylphosphine oxide, bisacylphosphine oxide or titanocene, fluorescein, anthraquinone, thioxanthone or xanthone, lophine dimer, trihalomethyl or dihalomethyl compounds, active ester compounds, and organic boron compounds.

Furthermore, a photo-cross-linkable radical generator such as a bisazide compound may be used in combination. In a case in which the polymerization is conducted under heat only, a typical thermal polymerization initiator such as azobisisobutyronitrile (AIBN) that is a typical photoradical generator can be used.

On the other hand, a mixture of a photoacid generator that generates an acid by irradiation with light and at least one monomer that is polymerizable in the presence of an acid achieves a similar function. When such a liquid ink (i.e., mixture) is irradiated with light, the photoacid generator generates an acid, and this acid functions as a catalyst for a cross-linking reaction of the polymerizable compound.

The generated acid diffuses in the ink layer. The acid diffusion and the acid-catalyzed cross-linking reaction can be accelerated by heating. This cross-linking reaction is not inhibited by the presence of oxygen, unlike radical polymerizations. The resulting resin layer has excellent adhesion property as compared with radical-polymerized resin layers.

Examples of the polymerizable compound cross-linkable in the presence of an acid include, but are not limited to, monomers having a cationically-polymerizable vinyl bond, such as compounds having a cyclic ether group such as epoxy group, oxetane group, and oxolane group, acrylic or vinyl compounds having the above-described substituent on a side chain, carbonate compounds, low-molecular-weight melamine compounds, vinyl ethers and vinylcarbazoles, styrene derivatives, α-methylstyrene derivatives, vinyl alcohol esters such as ester compounds of vinyl alcohols with acrylic acid or methacrylic acid, and combinations thereof.

Examples of the photoacid generator that generates an acid by irradiation with light include, but are not limited to, onium salts, diazonium salts, quinone diazide compounds, organic halides, aromatic sulfonate compounds, bisulfone compounds, sulfonyl compounds, sulfonate compounds, sulfonium compounds, sulfamide compounds, iodonium compounds, sulfonyl diazomethane compounds, and mixtures thereof.

Among these, onium salts are preferred as the photoacid generator. Examples of usable onium salts include, but are not limited to, diazonium salts, phosphonium salts, and sulfonium salts, each having a counter ion such as a fluoroborate anion, a hexafluoroantimonate anion, a hexafluoroarsenate anion, a trifluoromethanesulfonate anion, a p-toluenesulfonate anion, and a p-nitrotoluenesulfonate anion. Examples of the photoacid generator further include halogenated triazine compounds.

The photoacid generator may further contain a sensitizing dye. Examples of the sensitizing dye include, but are not limited to, acridine compounds, benzoflavins, perylene, anthracene, and laser dyes.

The porogen is mixed to form voids in the cured porous insulating layer. The porogen is arbitrarily selected from liquid substances capable of dissolving the polymerizable compound and the compound that generates a radical or an acid by light or heat and causing phase separation in the process in which the polymerizable compound and the compound that generates a radical or an acid by light or heat get polymerized.

Examples of the porogen include, but are not limited to: ethylene glycols such as diethylene glycol monomethyl ether, ethylene glycol monobutyl ether, and dipropylene glycol monomethyl ether; esters such as γ-butyrolactone and propylene carbonate; and amides such as N,N-dimethylacetamide.

In addition, liquid substances having a relatively large molecular weight, such as methyl tetradecanoate, methyl decanoate, methyl myristate, and tetradecane, also tend to function as the porogen. In particular, many ethylene glycols have a high boiling point. In the phase separation mechanism, the structure to be formed largely depends on the concentration of the porogen. When the above-described liquid substance is used, the porous insulating layer can be reliably formed. Each of the above-described porogens may be used alone or in combination with others.

Preferably, the ink has a viscosity of from 1 to 150 mPa·s, more preferably from 5 to 20 mPa·s, at 25 degrees C. Further, the solid content concentration of the polymerizable compound in the liquid composition is preferably from 5% to 70% by mass, more preferably from 10% to 50% by mass. When the viscosity is in the above-described range, the ink penetrates into the gaps between the active materials after being applied, so that the porous insulating layer 13 and the porous insulating layer 23 can be present inside the negative electrode composite layer 12 and the positive electrode composite layer 22, respectively.

When the concentration of the polymerizable compound is above the above-described range, the viscosity of the ink increases, and it becomes difficult to form the porous insulating layer inside the active material. In addition, the void becomes as small as several tens of nanometers or less, which is more difficult for the electrolyte to permeate. When the concentration of the polymerizable compound is below the above-described range, it is likely that a three-dimensional network structure is not sufficiently formed in the resin and the strength of the resulting porous insulating layer is remarkably lowered.

With respect to the distribution of the porous insulating layers 13 and 23, it is sufficient that the porous insulating layers 13 and 23 penetrate to the degree that improvement in adhesion is expected, and it is not necessary that the porous insulating layers 13 and 23 present deep inside the negative electrode composite layer 12 and the positive electrode composite layer 22, respectively. There is a case in which the anchor effect is exhibited when the porous insulating layer is sufficiently following the surface irregularities of the active materials and slightly penetrates into the gaps between the active materials. For this reason, although the optimum degree of penetration greatly depends on the material and shape of the active material, it is preferable that the porous insulating layers 13 and 23 be present 0.5% or more inside, more preferably 1.0% or more inside, of the negative electrode composite layer 12 and the positive electrode composite layer 22, respectively, in the depth direction (Z direction) from the surface thereof. The internal presence distribution can be appropriately adjusted according to the specification target of the secondary battery element.

The method for forming the porous insulating layers 13 and 23 is not particularly limited as long as it is formed with the ink. Examples thereof include, but are not limited to, spin coating, casting, micro gravure coating, gravure coating, bar coating, roll coating, wire bar coating, dip coating, slit coating, capillary coating, spray coating, nozzle coating, and various printing methods such as gravure printing, screen printing, flexo printing, offset printing, reverse printing, and inkjet printing.

### Separator

The separator 30 is provided between the negative electrode 10 and the positive electrode 20 in order to prevent a short circuit between the negative electrode 10 and the positive electrode 20. The separator 30 is an insulating layer having ion permeability and no electron conductivity. The material, shape, size, and structure of the separator 30 is not particularly limited and can be suitably selected to suit to a particular application.

Examples of the material of the separator 30 include, but are not limited to, papers such as Kraft paper, vinylon mixed paper, and synthetic pulp mixed paper, cellophane, polyethylene grafted films, polyolefin non-woven fabrics such as polypropylene melt-flow non-woven fabric, polyamide non-woven fabrics, glass fiber non-woven fabrics, polyethylene microporous films, and polypropylene microporous films.

Among these, those having a porosity of 50% or more are preferred for retaining the electrolyte. As the separator 30, a material in which fine particles of ceramics such as alumina and zirconia are mixed with a binder and a solvent may also be used. In this case, the average particle diameter of the fine particles of ceramics is preferably about 0.2 to 3.0 μm. In this case, lithium ion permeability can be provided. The average thickness of the separator 30 is not particularly limited and can be suitably selected to suit to a particular application, but is preferably from 3 to 50 μm, more preferably from 5 to 30 μm. The structure of the separator 30 may be either a single-layer structure or a multi-layer structure.

### Electrolyte Layer

The electrolyte component included in the electrolyte layer 51 may be either a solution of a solid electrolyte dissolved in a solvent or a liquid electrolyte such as an ionic liquid. Examples of the material of the electrolyte include, but are not limited to, inorganic ion salts (e.g., alkali metal salts, alkali-earth metal salts), quaternary ammonium salts, and supporting salts of acids and bases. Specific examples thereof include, but are not limited to, LiClO₄, LiBF₄, LiAsF₆, LiPF₆, LiCF₃SO₃, LiCF₃COO, KCl, NaClO₃, NaCl, NaBF₄, NaSCN, KBF₄, Mg(ClO₄)₂, and Mg(BF₄)₂.

Specific examples of the solvent that dissolves the solid electrolyte include, but are not limited to, propylene carbonate, acetonitrile, γ-butyrolactone, ethylene carbonate, sulfolane, dioxolan, tetrahydrofuran, 2-methyltetrahydrofuran, dimethylsulfoxide, 1,2-dimethoxyethane, 1,2-ethoxymethoxyethane, polyethylene glycol, alcohols, and mixed solvents thereof.

In addition, ionic liquids containing these cationic components and anionic components can also be used.

The ionic liquids are not particularly limited, and all ionic liquids having been generally researched or reported can be used. Some organic ionic liquids exhibit liquidity in 2 0 a wide temperature range including room temperature and comprise a cationic component and an anionic component.

Specific examples of cationic component include, but are not limited to, imidazole derivatives (e.g., N,N-dimethylimidazole salt, N,N-methylethylimidazole salt, N,N-methylpropylimidazole salt), aromatic salts of pyridinium derivatives (e.g., N,N-dimethylpyridinium salt, N,N-methylpropylpyridinium salt), and aliphatic quaternary ammonium compounds such as tetraalkylammonium compounds (e.g., trimethylpropylammonium salt, trimethylhexylammonium salt, triethylhexylammonium salt).

For stability in the atmosphere, specific preferred examples of the anionic component include, but are not limited to, fluorine-containing compounds such as BF₄⁻, CF₃SO₃⁻, PF₄⁻, (CF₃SO₂)₂N^{-l , B(CN}₄)⁻.

The amount of the electrolyte salt in the non-aqueous solvent is not particularly limited and can be suitably selected to suit to a particular application, but is preferably from 0.7 to 4 mol/L, more preferably from 1.0 to 3 mol/L, and particularly preferably from 1.0 to 2.5 mol/L, for achieving a good balance between the capacity and the output of the power storage element.

### Method for Manufacturing Non-Aqueous Electrolyte Power Storage Element

### Preparation of Negative Electrode and Positive Electrode

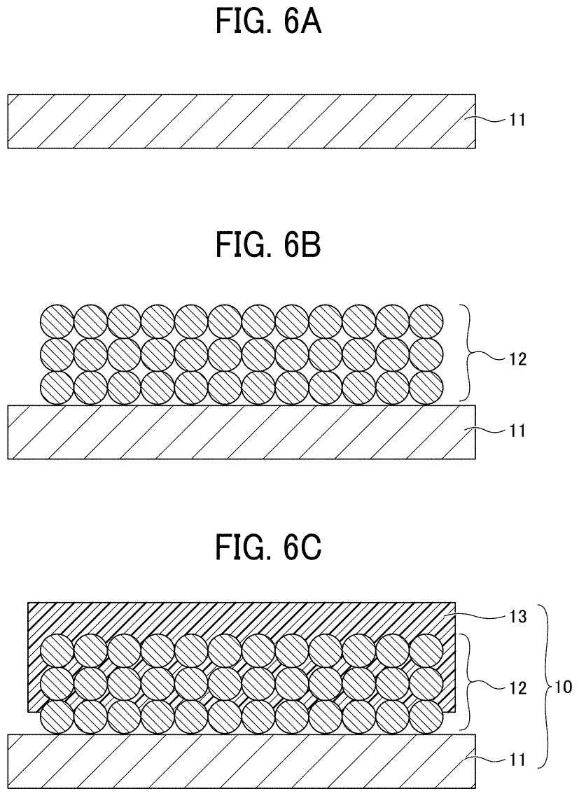

First, as illustrated in FIGS. 6A to 6C, the negative electrode 10 is prepared. Specifically, first, as illustrated in FIG. 6A, the negative electrode substrate 11 is prepared. The material and the like of the negative electrode substrate 11 are as described above.

Next, as illustrated in FIG. 6B, the negative electrode composite layer 12 is formed on the negative electrode substrate 11. Specifically, a negative electrode active material dispersion may be prepared by uniformly dispersing in water a negative electrode active material such as graphite particles, a thickener such as cellulose, and a binder such as an acrylic resin. Next, the above-prepared negative electrode active material dispersion is applied onto the negative electrode substrate 11, and the resulting coating film is dried and pressed, thus forming the negative electrode composite layer 12.

Next, as illustrated in FIG. 6C, the porous insulating layer 13 is formed on the negative electrode composite layer 12. The porous insulating layer 13 may be formed by preparing a material (e.g., ink) in which a precursor containing a photo- or thermal polymerization initiator and a polymerizable compound are dissolved in a liquid, applying the prepared material onto the negative electrode composite layer 12 as an undercoat layer, then giving light or heat to the material to proceed a polymerization, and drying the applied liquid.

Specifically, a specific solution is prepared as an ink for forming a porous insulating layer, and the solution is applied onto the negative electrode composite layer 12 by a dispenser, die coating, or inkjet printing, or the like. After the application is completed, the ink is cured by irradiation with ultraviolet rays or the like and then heated on a hot plate or the like for a predetermined time, thus forming the porous insulating layer 13. Although the polymerizable compound has compatibility with the liquid, the compatibility with the liquid decreases as the polymerization proceeds to cause phase separation in the material.

Thus, the negative electrode 10 is formed. In the negative electrode 10, at least a part of the porous insulating layer 13 is present inside the negative electrode composite layer 12 and integrated with a surface of an active material constituting the negative electrode composite layer 12.

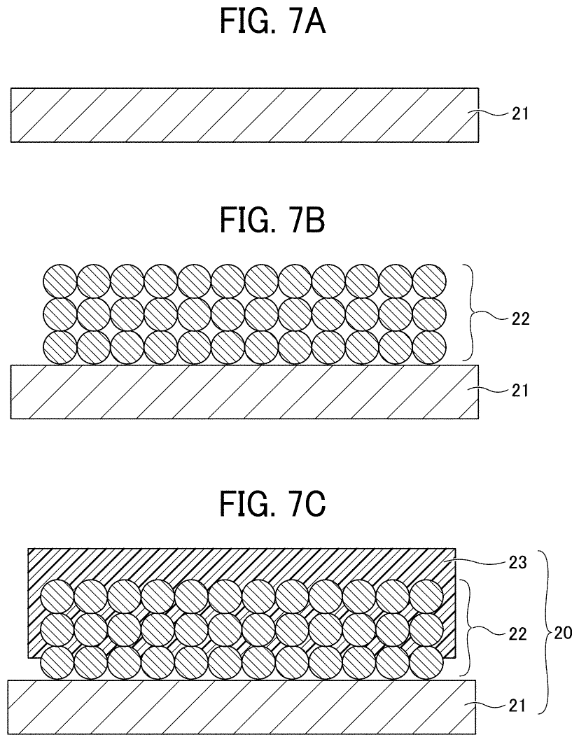

Next, as illustrated in FIGS. 7A to 7C, the positive electrode 20 is prepared. Specifically, first, as illustrated in FIG. 7A, the positive electrode substrate 21 is prepared. The material and the like of the positive electrode substrate 21 are as described above.

Next, as illustrated in FIG. 7B, the positive electrode composite layer 22 is formed on the positive electrode substrate 21. Specifically, a positive electrode active material dispersion may be prepared by uniformly dispersing in a solvent such as N-methylpyrrolidone a positive electrode active material such as mixed particles of nickel, cobalt, and aluminum, a conductive auxiliary agent such as Ketjen black, and a binder resin such as polyvinylidene fluoride. Next, the above-prepared positive electrode active material dispersion is applied onto the positive electrode substrate 21, and the resulting coating film is dried and pressed, thus forming the positive electrode composite layer 22.

Next, as illustrated in FIG. 7C, the porous insulating layer 23 is formed on the positive electrode composite layer 22. In the same manner as the porous insulating layer 13, the porous insulating layer 23 may be formed by preparing a material (e.g., ink) in which a precursor containing a photo- or thermal polymerization initiator and a polymerizable compound are dissolved in a liquid, applying the prepared material onto the positive electrode composite layer 22 as an undercoat layer, then giving light or heat to the material to proceed a polymerization, and drying the applied liquid.

Specifically, a specific solution is prepared as an ink for forming a porous insulating layer, and the solution is applied onto the positive electrode composite layer 22 by a dispenser, die coating, or inkjet printing, or the like. After the application is completed, the ink is cured by irradiation with ultraviolet rays or the like and then heated on a hot plate or the like for a predetermined time, thus forming the porous insulating layer 23. Although the polymerizable compound has compatibility with the liquid, the compatibility with the liquid decreases as the polymerization proceeds to cause phase separation in the material.

Thus, the positive electrode 20 is formed. In the positive electrode 20, at least a part of the porous insulating layer 23 is present inside the positive electrode composite layer 22 and integrated with a surface of an active material constituting the positive electrode composite layer 22.

### Preparation of Electrode Element and Non-Aqueous Electrolyte Power Storage Element

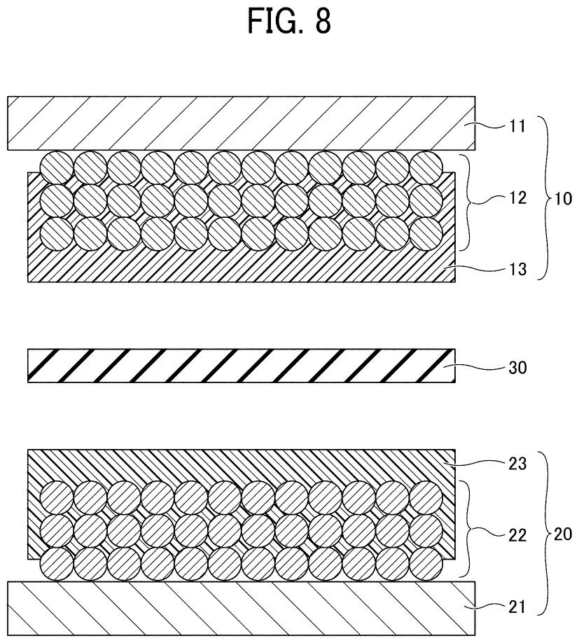

Next, an electrode element and a non-aqueous electrolyte power storage element are prepared. First, as illustrated in FIG. 8, the negative electrode 10 is placed on the positive electrode 20 such that the porous insulating layer 13 of the negative electrode 10 and the porous insulating layer 23 of the positive electrode 20 face each other via the separator 30 made of a polypropylene microporous film or the like. Next, the negative electrode lead wire 41 is joined to the negative electrode substrate 11 by welding or the like, and the positive electrode lead wire 42 is joined to the positive electrode substrate 21 by welding or the like, thereby preparing the electrode element 40 illustrated in FIG. 3. Next, the electrolyte layer 51 is formed by injecting a non-aqueous electrolyte into the electrode element 40 and sealed with the exterior 52, thus preparing the non-aqueous electrolyte power storage element 1 illustrated in FIG. 4.

In the negative electrode 10 used for the non-aqueous electrolyte power storage element 1 according to the present embodiment, at least a part of the porous insulating layer 13 is present inside the negative electrode composite layer 12 and integrated with a surface of the active material. Similarly, in the positive electrode 20, at least a part of the porous insulating layer 23 is present inside the positive electrode composite layer 22 and integrated with a surface of the active material.

With such an electrode structure, the resin constituting the porous insulating layers 13 and 23 is melted or softened at the time of shutdown and clings to the surface of the active material, thus forming a partition wall between the electrolyte and the active material. As a result, a reaction between the electrolyte and the active material is prevented, and the electrode effectively prevents thermal runaway and provides excellent safety.

In the negative electrode 10 and the positive electrode 20 used for the non-aqueous electrolyte power storage element 1 according to the present embodiment, the porous insulating layers 13 and 23 can be formed by irradiating a specific material with light or heat. Therefore, productivity of the porous insulating layers 13 and 23 can be improved.

Conventionally, because the functional layer having a shutdown effect is a film-shaped resin separator or is provided to the porous resin layer formed on the active material, even if it is melted or softened at the time of shutdown, the high-viscosity polymer does not penetrate between the electrode composite layers, and a sufficient thermal runaway preventing effect to completely prevent the reaction inside the electrode composite layer has not been expected.

### Modification 1 of First Embodiment

An electrode element according to Modification 1 of the first embodiment has a different structure from that according to the first embodiment. Note that in Modification 1 of the first embodiment, descriptions of the same components as those of the above-described embodiments may be omitted.

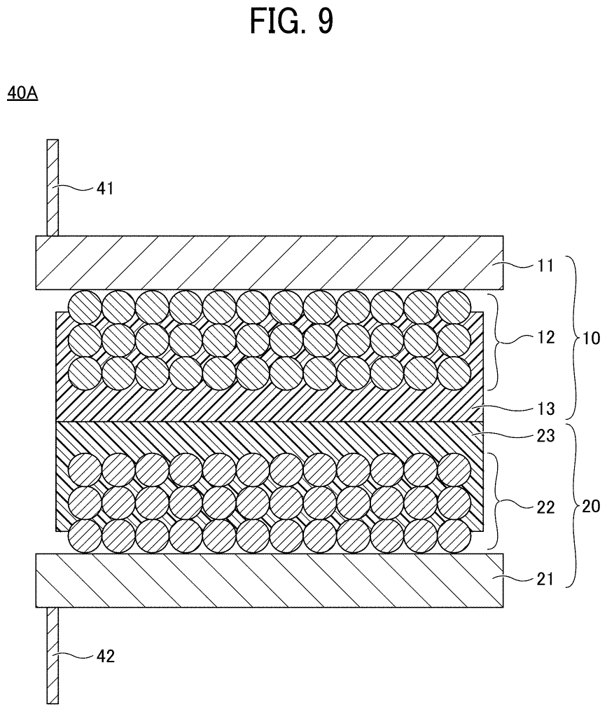

FIG. 9 is a cross-sectional view of an electrode element for use in a non-aqueous electrolyte power storage element according to Modification 1 of the first embodiment. Referring to FIG. 9, an electrode element 40A has a structure in which the negative electrode 10 and the positive electrode 20 are stacked such that the negative electrode substrate 11 and the positive electrode substrate 21 face outward and the porous insulating layer 13 and the porous insulating layer 23 are in direct contact with each other. A negative electrode lead wire 41 is connected to the negative electrode substrate 11. A positive electrode lead wire 42 is connected to the positive electrode substrate 21.

The electrode element 40A is different from the electrode element 40 in that the separator 30 (see FIG. 3) is omitted and the negative electrode 10 and the positive electrode 20 are stacked in direct contact with each other. By forming the electrolyte layer 51 by injecting a non-aqueous electrolyte into the electrode element 40A and sealing it with the exterior 52, a non-aqueous electrolyte power storage element is prepared.

When the negative electrode 10 and the positive electrode 20 are stacked such that the porous insulating layer 13 and the porous insulating layer 23 are in direct contact with each other, the porous insulating layers 13 and 23 function as separators and the separator 30 (see FIG. 3) can be omitted. Thus, the manufacturing cost of the electrode element 40A can be reduced.

Further understanding can be obtained by reference to certain specific examples of the non-aqueous electrolyte power storage element which are provided herein for the purpose of illustration only and are not intended to be limiting.

### EXAMPLE 1

The negative electrode 10, the positive electrode 20, the electrode element 40, and the non-aqueous electrolyte power storage element 1 were prepared by the following procedures [1] to [4].

### [1] Preparation of Ink

An insulating layer forming ink was prepared from the following materials.

EBECRYL 4101 (urethane acrylate oligomer, manufactured by DAICEL-ALLNEX LTD., elongation at break=27%, Tg of cured product=22 degrees C.): 29 parts by mass

Ethanol (manufactured by Kanto Chemical Co., Inc.): 70 parts by mass

IRGACURE 184 (manufactured by BASF): 1 part by mass

### [2] Preparation of Negative Electrode 10

A negative electrode active material dispersion was prepared by uniformly dispersing in water 97 parts by mass of graphite particles (having an average particle diameter of 10 μm) as a negative electrode active material, 1 part by mass of cellulose as a thickener, and 2 parts by mass of an acrylic resin as a binder. This dispersion was applied onto a copper foil having a thickness of 8 μm, serving as the negative electrode substrate 11, and the resulted coating film was dried at 120 degrees C. for 10 minutes and pressed, thus forming the negative electrode composite layer 12 having a thickness of 60 μm. Finally, the electrode was cut into a piece of 50 mm×33 mm.

Next, the ink prepared in [1] was applied onto the negative electrode composite layer 12 using a dispenser. After application of the ink, the ink was cured by irradiation with ultraviolet rays in an N₂ atmosphere, then heated on a hot plate at 120 degrees C. for 1 minute to remove the porogen. Thus, the negative electrode 10 having the porous insulating layer 13 was prepared.

### [3] Preparation of Positive Electrode 20

A positive electrode active material dispersion was prepared by uniformly dispersing in N-methylpyrrolidone as a solvent 94 parts by mass of mixed particles of nickel, cobalt, and aluminum as a positive electrode active material, 3 parts by mass of Ketjen black as a conductive auxiliary agent, and 3 parts by mass of polyvinylidene fluoride as a binder resin. This dispersion was applied onto an aluminum foil having a thickness of 15 μm, serving as the positive electrode substrate 21, and the resulted coating film was dried at 120 degrees C. for 10 minutes and pressed, thus forming the positive electrode composite layer 22 having a thickness of 50 μm. Finally, the electrode was cut into a piece of 43 mm×29 mm.

Next, the ink prepared in [1] was applied onto the positive electrode composite layer 22 using a dispenser, and the positive electrode 20 having the porous insulating layer 23 was prepared in the same manner as in [2].

### [4] Preparation of Electrode Element 40 and Non-Aqueous Electrolyte Power Storage Element 1

The negative electrode 10 was opposed to the positive electrode 20 via the separator 30 made of a polypropylene microporous film having a thickness of 25 μm. Specifically, the negative electrode 10 was placed on the positive electrode 20 such that the porous insulating layer 13 of the negative electrode 10 and the porous insulating layer 23 of the positive electrode 20 faced each other via the separator 30 made of a polypropylene microporous film. Next, the negative electrode lead wire 41 was joined to the negative electrode substrate 11 by welding or the like, and the positive electrode lead wire 42 was joined to the positive electrode substrate 21 by welding or the like, thereby preparing the electrode element 40. Next, a non-aqueous electrolyte containing 1.5 M LiPF₆ in a mixed solvent of EC and DMC (EC:DMC=1:1) was injected into the electrode element 40 to form the electrolyte layer 51 and sealed with a laminate exterior material as the exterior 52. Thus, the non-aqueous electrolyte power storage element 1 was prepared.

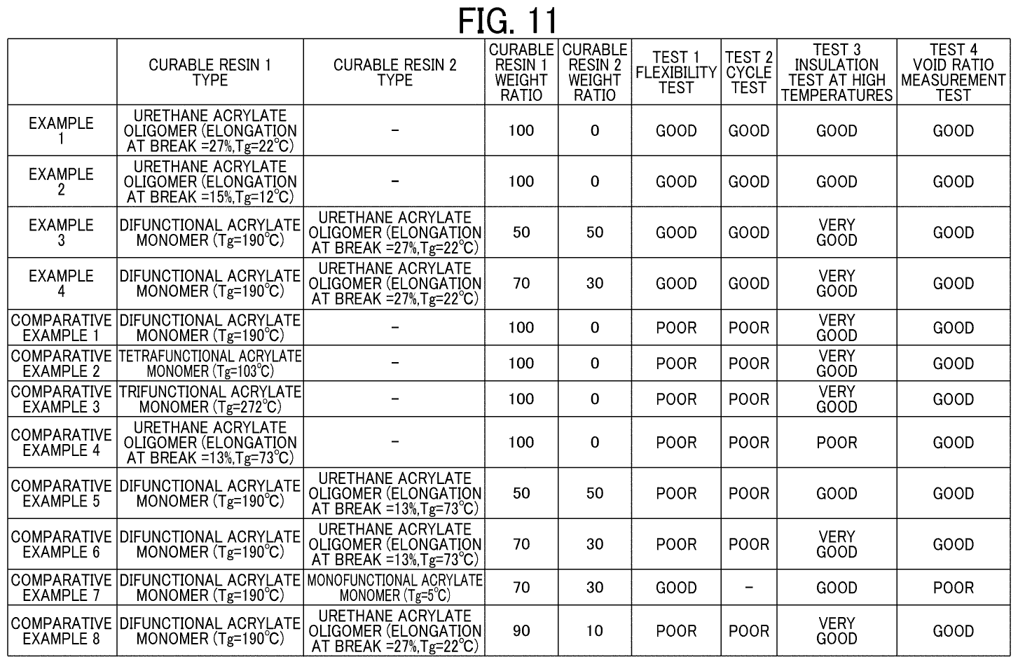

Next, the negative electrode and the positive electrode prepared in Example 1 each having the porous insulating layer were subjected to a flexibility test as Test 1. The test and evaluation procedures are as follows. The results are presented in FIG. 11.

### Test 1: Flexibility Test

The negative electrode or positive electrode of Example 1 each having the porous insulating layer was cut into a 100-mm square piece and subjected to a bending test in which the electrode was bent 20 times by a cylindrical mandrel bending tester (manufactured by COTEC) equipped with a cylindrical mandrel having a diameter of 4 mm. Before and after the bending test, the electrode was subjected to an observation to determine the presence or absence of cracks and to an evaluation of insulation property.

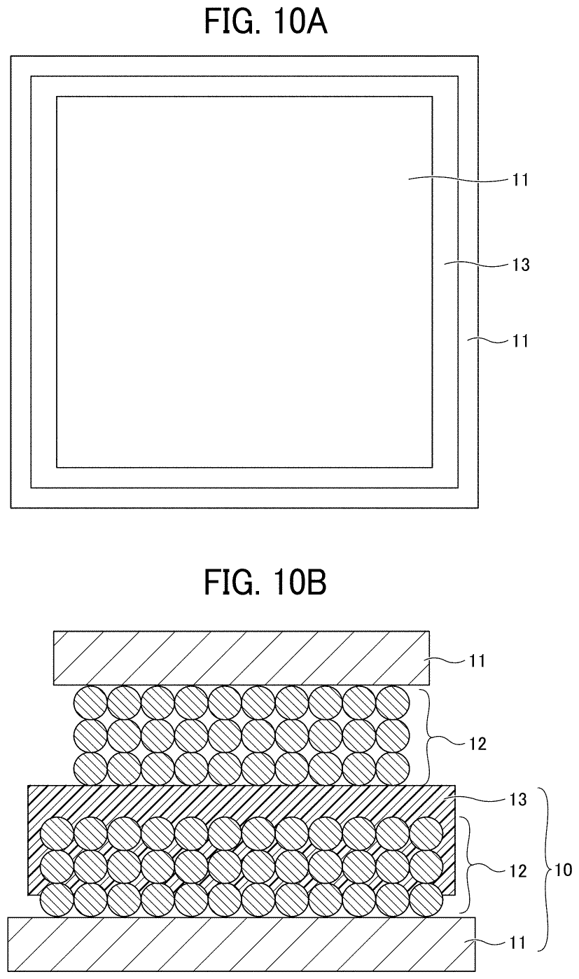

The presence or absence of cracks was evaluated by visual observation and an observation using an optical microscope. In the evaluation of insulation property, as illustrated in FIGS. 10A and 10B, the negative electrode substrate 11 having the negative electrode composite layer 12 was cut into a 80-mm square piece and pressed on the negative electrode 10 of Example 1 cut into a 100-mm square piece such that the negative electrode composite layer 12 and the porous insulating layer 13 were brought into contact with each other with their edge portions not overlapping each other. A direct current resistance value between the negative electrode substrates 11 on both sides was then measured with a tester. Insulating property of the positive electrode 20 was evaluated in the same manner. FIG. 10A is a plan view, and FIG. 10B is a cross-sectional view. Note that the one having no crack, a small change in direct current resistance value, and a large direct-current resistance value of 40 MΩ or more has excellent flexibility.

Evaluation Criteria

Good: No crack is observed, no change in direct current resistance value is observed before and after the bending test, and the direct current resistance value is 40 MΩ or more.

Poor: A crack is observed, a change in direct current resistance value is observed before and after the bending test, and the direct current resistance value is less than 40 MΩ.

Next, the non-aqueous electrolyte power storage element 1 of Example 1 was subjected to a cycle test as Test 2. The test and evaluation procedures are as follows. The results are presented in FIG. 11

### Test 2: Cycle Test

A capacity retention rate (cycle characteristics) at 500 times of driving of the non-aqueous electrolyte power storage element 1 of Example 1 was measured.

The cycle conditions were such that the SOC (state of charge) range was set to 100% and the rate was set to 2C.

In the evaluation of characteristics, the SOC range was set to 100% and the rate was set to 1C.

Evaluation Criteria

Good: Capacity retention rate is 80% or more.

Poor: Capacity retention rate is less than 80%.

Next, the non-aqueous electrolyte power storage element 1 of Example 1 was subjected to an insulation test at high temperatures as Test 3. The test and evaluation procedures are as follows. The results are presented in FIG. 11.

### Test 3: Insulation Test at High Temperatures

The non-aqueous electrolyte power storage element 1 was subjected to an evaluation of insulation property between the positive electrode and the negative electrode at high temperatures. Specifically, after maintaining the non-aqueous electrolyte power storage element 1 at each temperature of 25 degrees C., 160 degrees C., and 180 degrees C. for 15 minutes, the resistance value between the negative electrode 10 and the positive electrode 20 was checked if it was 40 MΩ or more, while maintaining the temperature. The results were evaluated according to the following criteria.

Evaluation Criteria

Very Good: 40 MΩ or more at 25 degrees C., 160 degrees C., and 180 degrees C.

Good: 40 MΩ or more at 25 degrees C. and 160 degrees C., and 1 MΩ or more and less than 40 MΩ at 180 degrees C.

Poor: 40 MΩ or more at 25 degrees C., 1 MΩ or more and less than 40 MΩ at 160 degrees C. and 180 degrees C.

Next, the negative electrode and positive electrode of Example 1 each having the porous insulating layer were subjected to a void ratio measurement test as Test 4. The test and evaluation procedures are as follows. The results are presented in FIG. 11.

### Test 4: Void Ratio Measurement Test

The negative electrode or positive electrode of Example 1 having the porous insulating layer was filled with an unsaturated fatty acid (commercially available butter) and dyed with osmium. Next, a cross section of the internal structure of the insulating layer was cut out with a focused ion beam (FIB) and observed with a scanning electron microscope (SEM) to measure the void ratio of the insulating layer. The measured void ratio was evaluated according to the following criteria.

Evaluation Criteria

Good: The void ratio is 30% or more.

Poor: The void ratio is less than 30%.

### Example 2

### [1] Preparation of Ink

An insulating layer forming ink was prepared from the following materials.

EBECRYL 4201 (urethane acrylate oligomer, manufactured by DAICEL-ALLNEX LTD., elongation at break=15%, Tg of cured product=12 degrees C.): 29 parts by mass

Ethanol (manufactured by Kanto Chemical Co., Inc.): 70 parts by mass

IRGACURE 184 (manufactured by BASF): 1 part by mass

After preparation of the ink, the non-aqueous electrolyte power storage element 1 was prepared in the same manner as in [2] to [4] of Example 1.

Next, the electrodes prepared in Example 2 and the non-aqueous electrolyte power storage element 1 prepared in Example 2 were subjected to Tests 1 to 4 in the same manner as in Example 1. The results are presented in FIG. 11.

### Example 3

### [1] Preparation of Ink

An insulating layer forming ink was prepared from the following materials.

EBECRYL 130 (difunctional acrylate monomer, manufactured by DAICEL-ALLNEX LTD., Tg of cured product=190 degrees C.): 14.5 parts by mass

EBECRYL 4101 (urethane acrylate oligomer, manufactured by DAICEL-ALLNEX LTD., elongation at break=27%, Tg of cured product=22 degrees C.): 14.5 parts by mass

Ethanol (manufactured by Kanto Chemical Co., Inc.): 70 parts by mass

IRGACURE 184 (manufactured by BASF): 1 part by mass

After preparation of the ink, the non-aqueous electrolyte power storage element 1 was prepared in the same manner as in [2] to [4] of Example 1.

Next, the electrodes prepared in Example 3 and the non-aqueous electrolyte power storage element 1 prepared in Example 3 were subjected to Tests 1 to 4 in the same manner as in Example 1. The results are presented in FIG. 11.

### Example 4

### [1] Preparation of Ink

An insulating layer forming ink was prepared from the following materials.

EBECRYL 130 (difunctional acrylate monomer, manufactured by DAICEL-ALLNEX LTD., Tg of cured product=190 degrees C.): 20.3 parts by mass

EBECRYL 4101 (urethane acrylate oligomer, manufactured by DAICEL-ALLNEX LTD., elongation at break=27%, Tg of cured product=22 degrees C.): 8.7 parts by mass

Ethanol (manufactured by Kanto Chemical Co., Inc.): 70 parts by mass

IRGACURE 184 (manufactured by BASF): 1 part by mass

After preparation of the ink, the non-aqueous electrolyte power storage element 1 was prepared in the same manner as in [2] to [4] of Example 1.

Next, the electrodes prepared in Example 4 and the non-aqueous electrolyte power storage element 1 prepared in Example 4 were subjected to Tests 1 to 4 in the same manner as in Example 1. The results are presented in FIG. 11.

### Comparative Example 1

### [1] Preparation of Ink

An insulating layer forming ink was prepared from the following materials.

EBECRYL 130 (difunctional acrylate monomer, manufactured by DAICEL-ALLNEX LTD., Tg of cured product=190 degrees C.): 29 parts by mass

Ethanol (manufactured by Kanto Chemical Co., Inc.): 70 parts by mass

IRGACURE 184 (manufactured by BASF): 1 part by mass

After preparation of the ink, a non-aqueous electrolyte power storage element was prepared in the same manner as in [2] to [4] of Example 1.

Next, the electrodes prepared in Comparative Example 1 and the non-aqueous electrolyte power storage element prepared in Comparative Example 1 were subjected to Tests 1 to 4 in the same manner as in Example 1. The results are presented in FIG. 11.

### Comparative Example 2

### [1] Preparation of Ink

An insulating layer forming ink was prepared from the following materials.

Pentaerythritol tetraacrylate (tetrafunctional acrylate monomer, manufactured by ARKEMA K.K., Tg of cured product=103 degrees C.): 29 parts by mass

Ethanol (manufactured by Kanto Chemical Co., Inc.): 70 parts by mass

IRGACURE 184 (manufactured by BASF): 1 part by mass

After preparation of the ink, a non-aqueous electrolyte power storage element was prepared in the same manner as in [2] to [4] of Example 1.

Next, the electrodes prepared in Comparative Example 2 and the non-aqueous electrolyte power storage element prepared in Comparative Example 2 were subjected to Tests 1 to 4 in the same manner as in Example 1. The results are presented in FIG. 11.

### Comparative Example 3

### [1] Preparation of Ink

An insulating layer forming ink was prepared from the following materials.

Tris(2-hydroxyethyl)isocyanurate triacrylate (trifunctional acrylate monomer, manufactured by ARKEMA K.K., Tg of cured product=272 degrees C.): 29 parts by mass

Ethanol (manufactured by Kanto Chemical Co., Inc.): 70 parts by mass

IRGACURE 184 (manufactured by BASF): 1 part by mass

After preparation of the ink, a non-aqueous electrolyte power storage element was prepared in the same manner as in [2] to [4] of Example 1.

Next, the electrodes prepared in Comparative Example 3 and the non-aqueous electrolyte power storage element prepared in Comparative Example 3 were subjected to Tests 1 to 4 in the same manner as in Example 1. The results are presented in FIG. 11.

### Comparative Example 4

### [1] Preparation of Ink

An insulating layer forming ink was prepared from the following materials.

EBECRYL 4265 (urethane acrylate oligomer, manufactured by DAICEL-ALLNEX LTD., elongation at break=13%, Tg of cured product=73 degrees C.): 29 parts by mass

Ethanol (manufactured by Kanto Chemical Co., Inc.): 70 parts by mass

IRGACURE 184 (manufactured by BASF): 1 part by mass

After preparation of the ink, a non-aqueous electrolyte power storage element was prepared in the same manner as in [2] to [4] of Example 1.

Next, the electrodes prepared in Comparative Example 4 and the non-aqueous electrolyte power storage element prepared in Comparative Example 4 were subjected to Tests 1 to 4 in the same manner as in Example 1. The results are presented in FIG. 11.

### Comparative Example 5

### [1] Preparation of Ink

An insulating layer forming ink was prepared from the following materials.

EBECRYL 130 (difunctional acrylate monomer, manufactured by DAICEL-ALLNEX LTD., Tg of cured product=190 degrees C.): 14.5 parts by mass

EBECRYL 4265 (urethane acrylate oligomer, manufactured by DAICEL-ALLNEX LTD., elongation at break=13%, Tg of cured product=73 degrees C.): 14.5 parts by mass

Ethanol (manufactured by Kanto Chemical Co., Inc.): 70 parts by mass

IRGACURE 184 (manufactured by BASF): 1 part by mass

After preparation of the ink, a non-aqueous electrolyte power storage element was prepared in the same manner as in [2] to [4] of Example 1.

Next, the electrodes prepared in Comparative Example 5 and the non-aqueous electrolyte power storage element prepared in Comparative Example 5 were subjected to Tests 1 to 4 in the same manner as in Example 1. The results are presented in FIG. 11.

### Comparative Example 6

### [1] Preparation of Ink

An insulating layer forming ink was prepared from the following materials.

EBECRYL 130 (difunctional acrylate monomer, manufactured by DAICEL-ALLNEX LTD., Tg of cured product=190 degrees C.): 20.3 parts by mass

EBECRYL 4265 (urethane acrylate oligomer, manufactured by DAICEL-ALLNEX LTD., elongation at break=13%, Tg of cured product=73 degrees C.): 8.7 parts by mass

Ethanol (manufactured by Kanto Chemical Co., Inc.): 70 parts by mass

IRGACURE 184 (manufactured by BASF): 1 part by mass

After preparation of the ink, a non-aqueous electrolyte power storage element was prepared in the same manner as in [2] to [4] of Example 1.

Next, the electrodes prepared in Comparative Example 6 and the non-aqueous electrolyte power storage element prepared in Comparative Example 6 were subjected to Tests 1 to 4 in the same manner as in Example 1. The results are presented in FIG. 11.

### Comparative Example 7

### [1] Preparation of Ink

An insulating layer forming ink was prepared from the following materials.

EBECRYL 130 (difunctional acrylate monomer, manufactured by DAICEL-ALLNEX LTD., Tg of cured product=190 degrees C.): 20.3 parts by mass

2-Phenoxyethyl acrylate (monofunctional acrylate monomer, manufactured by DAICEL-ALLNEX LTD., Tg of cured product=5 degrees C.): 8.7 parts by mass

Ethanol (manufactured by Kanto Chemical Co., Inc.): 70 parts by mass

IRGACURE 184 (manufactured by BASF): 1 part by mass

After preparation of the ink, a non-aqueous electrolyte power storage element was prepared in the same manner as in [2] to [4] of Example 1.

Next, the electrodes prepared in Comparative Example 7 and the non-aqueous electrolyte power storage element prepared in Comparative Example 7 were subjected to Tests 1 to 4 in the same manner as in Example 1. The results are presented in FIG. 11.

### Comparative Example 8

### [1] Preparation of Ink

An insulating layer forming ink was prepared from the following materials.

EBECRYL 130 (difunctional acrylate monomer, manufactured by DAICEL-ALLNEX LTD., Tg of cured product=190 degrees C.): 26.1 parts by mass

EBECRYL 4101 (urethane acrylate oligomer, manufactured by DAICEL-ALLNEX LTD., elongation at break=27%, Tg of cured product=22 degrees C.): 2.9 parts by mass

Ethanol (manufactured by Kanto Chemical Co., Inc.): 70 parts by mass

IRGACURE 184 (manufactured by BASF): 1 part by mass After preparation of the ink, a non-aqueous electrolyte power storage element was prepared in the same manner as in [2] to [4] of Example 1.

Next, the electrodes prepared in Comparative Example 8 and the non-aqueous electrolyte power storage element prepared in Comparative Example 8 were subjected to Tests 1 to 4 in the same manner as in Example 1. The results are presented in FIG. 11.

Referring to FIG. 11, in Examples 1 and 2 each using a flexible curable resin having an elongation of 15% or more at break, favorable results were obtained in the flexibility test and the cycle test. Further, the results of Examples 3 and 4 indicate that heat resistance of the insulating layer is increased when a curable resin having a high Tg is used in combination.

The results of Comparative Examples 1 to 3 indicate that the cycle characteristics is poor when only a curable resin having poor flexibility is used. This is presumably because the flexibility of the insulating layer was poor, so that the insulating layer was broken without following expansion and shrinkage of the electrodes during driving of the battery.

Further, the results of Comparative Examples 4 to 6 indicate that a curable resin having an elongation of less than 15% at break cannot provide sufficient flexibility and cycle characteristics.

In Comparative Example 7, a monofunctional acrylate monomer was added to impart flexibility. The addition of the monofunctional acrylate monomer improves flexibility but lowers the cross-linking density. Therefore, the void ratio of the resulted insulating layer was insufficient in terms of ion permeability, and it was unable to perform the cycle test.

Finally, the results of Comparative Example 8 indicate that when the addition amount of a flexible curable resin having an elongation at break of 15% or more is less than 30%, the resulted insulating layer cannot be provided with sufficient flexibility and cycle characteristics.

In attempting to improve safety by forming an ion-permeable porous insulating layer in adhesive contact with the electrode composite layer with a heat-resistant cross-linked polymer as in Comparative Examples, the insulating layer will break when unable to follow expansion and shrinkage of the electrode composite layer during driving of the battery. Therefore, long-term reliability of the battery, such as cycle characteristics, deteriorate.

By contrast, in each Example, the direct current resistance value of the porous insulating layer is 40 MΩ or more either before or after the bending test in which the electrode is bent 20 times by a cylindrical mandrel bending tester equipped with a cylindrical mandrel having a diameter of 4 mm.

As a result, even in a case in which the porous insulating layer formed with the cross-linked polymer is in adhesive contact with the electrode, the electrode provides excellent long-term reliability such as cycle characteristics while maintaining the effect of improving safety when mounted on a power storage element.

The preferred embodiments have been described in detail above. However, the present invention is not limited to the above-described embodiments, and various modifications and substitutions can be made to the above-described embodiments without departing from the scope of the claims.

For example, in the above-described embodiments, both the negative electrode and the positive electrode of the electrode element have the porous insulating layer. In other embodiments, only one of the negative electrode and the positive electrode may have the porous insulating layer. In this case, the positive electrode and the negative electrode may be directly stacked or stacked via a separator.

Numerous additional modifications and variations are possible in light of the above teachings. It is therefore to be understood that, within the scope of the above teachings, the present disclosure may be practiced otherwise than as specifically described herein. With some embodiments having thus been described, it will be obvious that the same may be varied in many ways. Such variations are not to be regarded as a departure from the scope of the present disclosure and appended claims, and all such modifications are intended to be included within the scope of the present disclosure and appended claims.

1. An electrode comprising:
an electrode substrate;
an electrode composite layer on the electrode substrate, the electrode composite layer containing an active material; and
a porous insulating layer on the electrode composite layer, the porous insulating layer containing a resin as a main component,
wherein at least a part of the porous insulating layer is present inside the electrode composite layer and integrated with a surface of the active material,
wherein the porous insulating layer has a direct current resistance value of 40 MΩ or more either before or after a bending test in which the electrode is bent 20 times by a cylindrical mandrel bending tester equipped with a cylindrical mandrel having a diameter of 4 mm.

2. The electrode according to claim 1, wherein the resin comprises a polymer of a curable resin composition containing a curable resin having an elongation of 15% or more at break.

3. The electrode according to claim 2, wherein the curable resin has acryloyl group or methacryloyl group.

4. The electrode according to claim 2, wherein the curable resin is urethane acrylate or urethane methacrylate.

5. The electrode according to claim 2, wherein the curable resin accounts for 30% by weight or more of the resin.

6. The electrode according to claim 1, wherein the porous insulating layer has a cross-linked structure.

7. The electrode according to claim 1, wherein the porous insulating layer has a plurality of voids, and one of the voids is communicated with other voids around.

8. An electrode element comprising:
a negative electrode; and
a positive electrode
wherein the negative electrode and the positive electrode are stacked overlying each other with being insulated from each other,
wherein at least one of the negative electrode and the positive electrode is the electrode according to claim 1.

9. The electrode element according to claim 8, wherein the negative electrode and the positive electrode are stacked in contact with each other.

10. The electrode element according to claim 8, wherein the negative electrode and the positive electrode are stacked via a separator.

11. A non-aqueous electrolyte power storage element comprising:
the electrode element according to claim 8;
a non-aqueous electrolyte injected into the electrode element; and
an exterior sealing the electrode element and the non-aqueous electrolyte.

12. A method for manufacturing an electrode having a porous insulating layer on an undercoat layer, comprising:
forming the porous insulating layer including:
preparing a material in which a precursor including a first curable resin and a second curable resin is dissolved in a liquid;
applying the material onto the undercoat layer;
giving light or heat to the material after the applying to proceed a polymerization; and
drying the liquid,
wherein at least one of the first curable resin and the second curable resin is a curable resin having an elongation of 15% of more at break.

13. The method according to claim 12,
wherein the precursor contains a polymerizable compound,
wherein compatibility of the polymerizable compound with the liquid decreases as the polymerization proceeds to cause phase separation in the material.
